(19) United States
(12) Patent Application Publication
(10) Pub. No.: US 2003/0113488 A1
(43) Pub. Date: Jun. 19, 2003

(54) Device for holding a molten semiconductor material

(75) Inventor: Erich Tomzig, Burgkirchen (DE)

Correspondence Address: COLLARD & ROE, P.C., 1077 Northern Boulevard, Roslyn, NY, 11576, US

(73) Assignee: WACKER SILTRONIC AG

(21) Appl. No.: 10/318,712

(22) Filed: Dec. 13, 2002

(30) Foreign Application Priority Data
Dec. 19, 2001 (DE) 101 62 596.0
Oct. 31, 2002 (DE) 102 50 824.0

(51) Int. Cl. B32B 1/02

(52) U.S. Cl. 428/34.4

(57) ABSTRACT

A device for holding a molten semiconductor material, includes a crucible made from quartz glass and a susceptor which at least partially comprises CFC and which supports the crucible and an inner surface having a base, a cylindrical section and a curved section between the base and the cylindrical section, and a thin, sheet-like and flexibly deformable graphite film which is arranged between the crucible and the susceptor and forms a gastight barrier.

### BACKGROUND OF THE INVENTION

1. Field of the Invention

The present invention relates to a device for holding a molten semiconductor material, comprising a crucible made from quartz glass; a susceptor which at least partially comprises CFC; and a thin, sheet-like and flexibly deformable graphite film which is arranged between the crucible and the susceptor and said graphite film forms a gastight barrier.

2. The Prior Art

Single crystals made from semiconductor material, such as for example silicon, are produced, inter alia, using the Czochralski method. In this method, during the crystal growth a molten material is located in a crucible, which in the case of silicon consists of quartz glass. If the temperature of the molten material is more than 1250° C., the quartz glass crucible becomes soft and therefore has to be held by means of a susceptor (supporting crucible), as shown, for example, in U.S. Pat. No. 5,858,486. A susceptor generally consists of graphite or of a carbon matrix which is reinforced with carbon fibers (CFC). Quartz crucibles are usually only employed for in each case one production run in which generally only one crystal is produced, while susceptors are used for a series of production runs.

Since semiconductor material, such as silicon, gallium arsenide or gallium phosphide, expands during solidification, it is customary to use a two-part or three-part susceptor. This prevents the susceptor from being destroyed during solidification of residual molten material which has remained in the crucible after the crystal growth.

At the temperatures required for the production of single crystals, chemical reactions occur between the quartz glass crucible and the susceptor. As a result of these reactions oxygen from the quartz glass combines with carbon from the susceptor material to form carbon monoxide. Further products of this reaction are silicon carbide and silicon monoxide.

As a result of the chemical reaction, the susceptor is constantly losing mass which escapes as carbon monoxide. The higher the temperature and the easier it is for the carbon monoxide formed to escape, the greater the loss of substance becomes. The escape of carbon monoxide becomes easier in particular if one of the abovementioned multipart susceptors is used.

Furthermore, the chemical reaction corrodes the susceptor, in particular at locations such as pores, microcracks, the abutting surfaces of segments of multipart susceptors and the layer transitions of CFC susceptors which are of multilayer structure. Both the carbon matrix and the carbon fibers are attacked in this case. Silicon which originates from the quartz glass crucible, is deposited at the abovementioned locations and forms silicon carbide in combination with carbon and is responsible for this corrosion. In the case of multilayer susceptors, the corrosion may cause laminar flaking of the layers.

Both the loss of substance caused by the escape of carbon monoxide and the corrosion caused by the formation of silicon carbide reduce the service life of the susceptor. This entails a considerable economic drawback in particular when using susceptors made from expensive CFC material. Therefore, susceptors made from CFC are usually employed in single-part form, in order to offer the minimum possible surface area for the corrosion to attack.

WO-01/38625 discloses a CFC protective film which is inserted between the crucible and the supporting crucible, is corroded instead of the supporting crucible as a sacrificial layer and therefore has to be exchanged at regular intervals.

By contrast, WO-98/48085 discloses the providing of a barrier between the crucible and the supporting crucible which cannot react chemically either with the silicon dioxide of the crucible or with the carbon of the supporting crucible at temperatures in the range from approximately 1550° to approximately 180° C.

### SUMMARY OF THE INVENTION

It is an object of the present invention to counteract the chemical wear to a susceptor made from CFC and to increase the service life of the susceptor.

The above object is achieved according to the present invention by providing a device for holding a molten semiconductor material, comprising a crucible made from quartz glass and a susceptor which at least partially comprises CFC and which supports the crucible and comprises an inner surface having a base, a cylindrical section and a curved section between the base and the cylindrical section, which device has a thin, sheet-like and flexibly deformable film made from graphite, which is arranged between the crucible and the susceptor and forms a gastight barrier.

The sheet-like graphite film protects the susceptor against chemical attack and as a result makes it possible to increase the susceptor service life by a multiple. The costs of providing the graphite film are more than compensated for by the saving resulting from the increase in service life. A further advantage of the invention is that the graphite film facilitates the removal of the quartz glass crucible from the susceptor, particularly in the case of single-part susceptors made from CFC material. The quartz glass crucible often slips out of the susceptor of its own accord when it is placed upside down, preferably when conically shaped susceptors are being used.

The thin, sheet-like graphite film acts as a protective separating layer between the quartz glass crucible and the susceptor. It is preferably arranged where chemical attack on the susceptor is most likely. In addition to the locations which have already been mentioned, the susceptor is at particular risk at locations where it is exposed to the highest temperatures when it is being used as intended. During crystal growth, these locations are the base and the transition region between the base and the side wall of the susceptor. It is therefore particularly preferred for this area of the susceptor to be covered with the graphite film in such a manner that it covers the surface.

A particular feature of the graphite film is its property of simultaneously being gas-impermeable and flexible and of reacting chemically with silicon dioxide at temperatures from approximately 1440° to approximately 1550° C. By contrast, CFC films do not have the required gas-impermeability. To achieve this, a plurality of CFC films would have to be combined in a composite structure, which in turn would be to the detriment of the flexible deformability of the sheet-like structure. Furthermore, flexibly deformable graphite films have the advantage that they can readily be cut into a desired shape and are relatively inexpensive.

The gas-impermeability of the film is a necessary criterion, since only then can the susceptor be effectively protected from chemical degradation. It is therefore particularly preferable for there to be no joins or incisions which interrupt the coverage of the susceptor with the graphite film. According to one embodiment of the invention, the graphite film covers the base of the susceptor completely and is free of incisions. According to another embodiment of the invention, the graphite film covers the base of the susceptor and the curved section. According to a further embodiment of the invention, the graphite film covers the base of the susceptor, the curved section and a part of the cylindrical section. According to a further embodiment of the invention, the graphite film covers the base of the susceptor, the curved section and the cylindrical section completely.

The flexible deformability of the film is a further necessary criterion, which ensures that the gas-impermeability is retained when the crucible is in use. If the flexible deformability is absent, the film can no longer be connected to the susceptor in a positively locking manner. Furthermore, a rigid film may break when the crucible is in use and thereby lose its gas-impermeability.

Suitable graphite films are commercially available and are supplied in particular as sealing materials for applications at high temperatures, including, in particularly pure form, for applications in the semiconductor industry. They consist of compressed, for example rolled or pressed graphite. The thickness of the graphite film is preferably 0.05 to 3 mm, particularly preferably 0.2 to 0.5 mm. It may have to be taken into account during the production of the susceptor, so that there is sufficient space for holding the graphite film and the quartz crucible. The film is of one-layer or two-layer design, preferably of one-layer design. The inner wall of the susceptor is preferably lined with a single-piece graphite film of this type. Alternatively, the film may also be preshaped outside the susceptor and inserted into the susceptor as a flexibly deformable inlay. These inlays are very inexpensive compared to the susceptors and can be used for one or more production runs.

If a sheet-like graphite film which has not been preshaped is inserted into the susceptor, it is desirable for it to be provided with incisions. Thus the formation of creases during lining of the susceptor at highly curved locations is avoided, in particular in the curved section between the base and the cylindrical section of the susceptor. The incisions are preferably designed to be as short as possible and are limited in number. This is done in order for the graphite film to be interrupted at the minimum possible number of locations and, at the same time, to achieve the maximum possible overlap of the regions which are separated by incisions.

According to a preferred embodiment, the graphite film, before being arranged between the crucible and the susceptor, has a circular periphery and radial incisions which lead from the periphery, and has a diameter which substantially corresponds to the diameter of the crucible in the cylindrical region. A diameter of 1.1 to 1.8 times the diameter of the crucible is particularly preferred.

It is preferable for there to be fewer than 30 incisions, particularly preferably fewer than 15 incisions. Furthermore, it is preferable for the incisions to delimit a region without incisions, the diameter of which is at least 50%, particularly preferably at least 70%, of the diameter of the crucible, in the center of the film. It is preferable for there to be 12 or fewer incisions and for there to be a region without incisions and with a diameter of at least 70% of the diameter of the crucible.

According to a further preferred embodiment, the graphite film, after it has been arranged between the crucible and the susceptor, has incisions which only extend into the curved and/or cylindrical section of the crucible.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

FIG. 1 shows one embodiment of the invention; and

FIG. 2 shows a second embodiment of the invention.

### DETAILED DESCRIPTION OF PREFERRED EMBODIMENTS

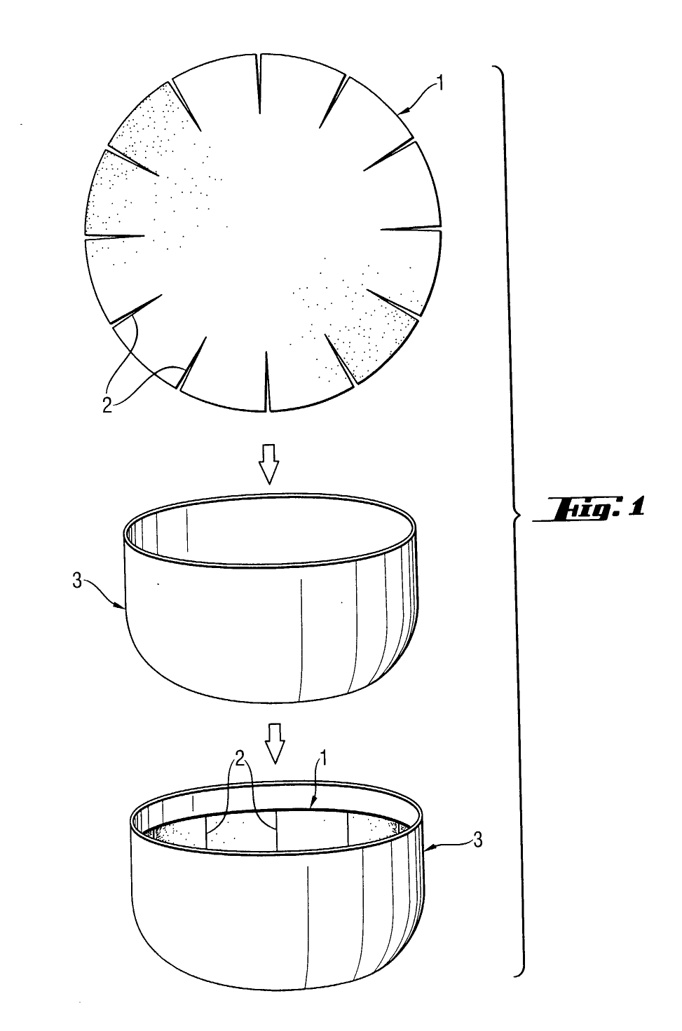

Turning now in detail to the drawings, the graphite film is shown in FIG. 1 and is a deformable, planar structure 1 with incisions 2 in the edge region, which acquires its definitive form when it is placed into the susceptor 3.

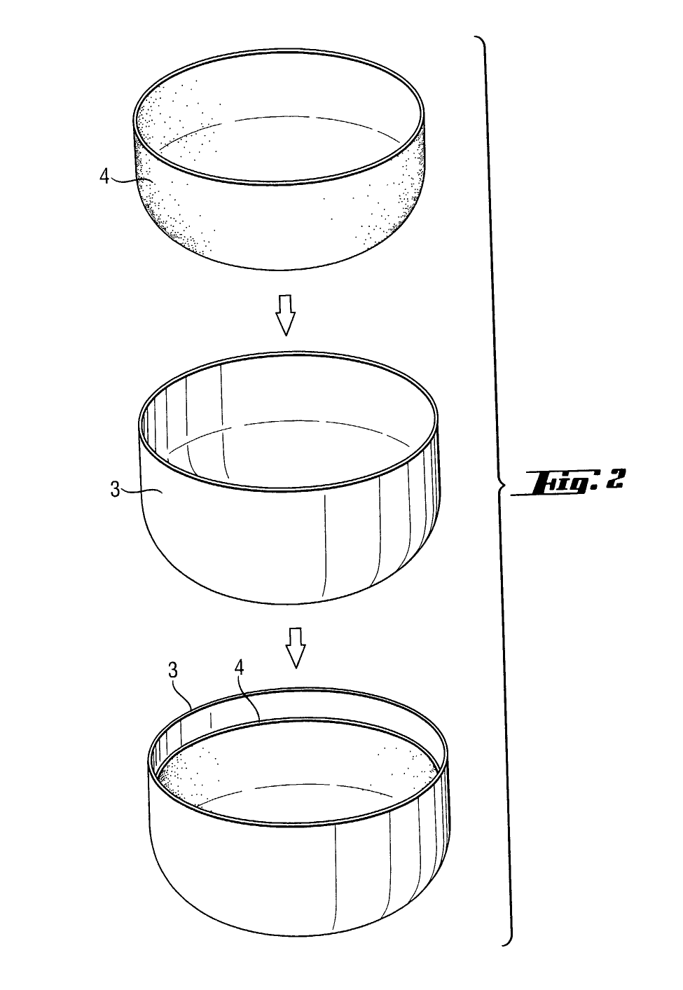

The graphite film shown in FIG. 2 is a preformed inlay 4 which is inserted into the susceptor 3.

The graphite film is easy to clean, generally using the same method as that used to clean the susceptor. This is important in connection with the production of semiconductor crystals, since as a result no additional impurities are entrained.

The invention is used to particularly good effect in combination with multipart susceptors, since this is where there are the greatest potential savings resulting from the increase in service life. Combination with multipart susceptors which are composed of graphite and CFC parts is particularly preferred. For example, the cylindrical section of the susceptor may consist of CFC and the curved section and the base may consist of graphite. However, this should not exclude the possibility of the invention also being used in combination with susceptors which consist entirely of CFC.

### COMPARATIVE EXAMPLE

Numerous tests using inlays made from various CFC materials were carried out using CFC susceptors with a diameter of 28 inches. These inlays were, for example, prepregs, flexible mats, woven fabrics, carbonized and graphited CFC mats and CFC films. The use of CFC materials as flexible inlays was only possible if they had just a few layers of woven fabric. When using CFC inlays, discoloration in the CFC susceptor caused by chemical reactions which take place despite the protective layer was observed even after the first pulling operation. After several runs, clear evidence of corrosion caused by chemical reaction was already apparent. In the light of the invention, this result can be attributed to the fact that the flexible CFC inlays were not gastight. With CFC inlays, it was impossible to significantly lengthen the service life of the CFC susceptors in the way which was achieved when using graphite films.

Moreover, it was not possible for the CFC materials to be used for 2 successive runs. After use, they had become so brittle that they disintegrated completely when the quartz-glass crucible together with the residual molten material was removed from the susceptor. Since inlays made from CFC materials are relatively expensive, therefore, they are not worth using, in view of the minor increase in the service life of the CFC susceptors which they are able to bring about (at most a factor of 2).

### EXAMPLE 1 (INVENTION)

Under conditions which were otherwise identical to those used in the Comparative Example, graphite inlays were inserted instead of inlays made from CFC material. Inlays which covered the susceptor at the base and in the radius region were used. The inlays were used right from the initial deployment of the susceptor. The appearance of the susceptor was checked after each run. The area which was covered by the films over the entire surface did not reveal any corrosive attack whatsoever. Initial discoloration had occurred directly above the inserted graphite film. After a large number of runs, this region became brittle as a result of the ceramicization until ultimately first partial regions of the susceptor broke off here. Even when inlays of this size were used, it was possible to achieve a mean increase in the service life of a factor of 3.

### EXAMPLE 2 (INVENTION)

Under conditions which were otherwise identical to those used in Example 1, a further series of tests used graphite inlays which covered not only the base and the radius region of the susceptor with a diameter of 28 inches, but also half the cylindrical part of the susceptor. This made it possible to achieve a mean increase in service life of a factor of 5.

Accordingly, while a few embodiments of the present invention have been shown and described, it is to be understood that many changes and modifications may be made thereunto without departing from the spirit and scope of the invention as defined in the appended claims.

What is claimed is:

1. A device for holding a molten semiconductor material, comprising
a crucible made from quartz glass;
a susceptor which at least partially comprises CFC and which supports the crucible and comprises an inner surface having a base, a cylindrical section and a curved section between the base and the cylindrical section; and
a thin, sheet-like and flexibly deformable graphite film which is arranged between the crucible and the susceptor and said graphite film forms a gastight barrier.

2. The device as claimed in claim 1,
wherein the graphite film covers part of the inner surface of the susceptor.

3. The device as claimed in claim 1,
wherein the graphite film completely covers the inner surface of the susceptor.

4. The device as claimed in claim 1,
wherein the graphite film covers locations on the inner surface of the susceptor which are exposed to the highest temperatures when the susceptor is being used as intended.

5. The device as claimed in claim 1,
wherein the graphite film completely covers the base of the susceptor and is free of incisions.

6. The device as claimed in claim 1,
wherein the graphite film covers the base of the susceptor and the curved section.

7. The device as claimed in claim 1,
wherein the graphite film covers the base of the susceptor, the curved section and part of the cylindrical section.

8. The device as claimed in claim 1,
wherein the graphite film, before it is arranged between the crucible and the susceptor, has a circular periphery and radial incisions leading from the periphery, and has a diameter which substantially corresponds to a diameter of the crucible in the cylindrical region.

9. The device as claimed in claim 8,
which has fewer than 30 incisions.

10. The device as claimed in claim 8,
wherein the film has a region with no incisions and with a diameter which is at least 50% of the diameter of the crucible in the cylindrical region.

11. The device as claimed in claim 8,
wherein the incisions, after the graphite film has been arranged between the crucible and the susceptor, extend only into a section selected from the group consisting of the curved section, the cylindrical section, and the curved section and cylindrical section.

12. The device as claimed in claim 1,
wherein the graphite film is 0.05 to 3 mm thick.

13. The device as claimed in claim 1,
wherein the susceptor is of multipart structure.

14. The device as claimed in claim 13,
wherein the graphite film covers separating locations between segments of the multipart susceptor.

15. The device as claimed in claim 13,
wherein the susceptor is of multipart design and the cylindrical section of the susceptor consists of CFC and the curved section and the base consist of graphite.

16. In a method for producing a single crystal from semiconductor material, the improvement which comprises,
utilizing the device of claim 1 for said producing.
